(19) United States
(12) Patent Application Publication
(10) Pub. No.: US 2009/0219471 A1
(43) Pub. Date: Sep. 3, 2009

(54) ELECTRO-OPTICAL DEVICE AND METHOD OF MANUFACTURING ELECTRO-OPTICAL DEVICE

(75) Inventor: Hiroshi Mochiku, Sapporo-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/394,166

(22) Filed: Feb. 27, 2009

(30) Foreign Application Priority Data
Feb. 29, 2008 (JP) 2008-049288

(51) Int. Cl. G02F 1/1333

(52) U.S. Cl. 349/110

(57) ABSTRACT

An electro-optical device includes a substrate, a first light-shielding layer over the substrate, a first interlayer insulating layer over1 the first light-shielding layer, a transistor over the first interlayer insulating layer, a second interlayer insulating layer over the transistor, and a second light-shielding layer over the second interlayer insulating layer. The first interlayer insulating layer has a thinnest portion that is located between an end portion of the first light-shielding layer and an end portion of the second light-shielding layer in plan view.

### BACKGROUND

1. Technical Field

The present invention relates to an electro-optical device and a method of manufacturing the electro-optical device.

2. Related Art

In recent years, electronic apparatuses such as mobile phones, mobile computers, and video cameras have been widely used. The electronic apparatuses have display sections including electro-optical devices such as liquid crystal devices The liquid crystal devices include thin-film transistors (TFTs) for driving liquid crystals and have a problem that light reaches the TFTs to cause leakage currents and the leakage currents cause a reduction in display quality. In order to solve the problem, for example, JP-A-10-301100 discloses a liquid crystal device in which a light-shielding layer is placed on at least one of the upper and lower sides of TFTs such that the TFTs are shielded from light. Furthermore, JP-A-2000-330133 discloses a liquid crystal device in which a light-shielding layer has a first surface facing TFTs and a second surface opposite to the first surface and the first surface and the second surface have low light reflectance and high light reflectance, respectively, such that the TFTs are shielded from light.

In these liquid crystal devices, the light-shielding layers are tabular and therefore cannot completely block light transversely or obliquely incident on the TFTs. Therefore, these liquid crystal devices have a problem that a reduction in display quality due to leakage currents cannot be sufficiently prevented.

### SUMMARY

An advantage of an aspect of the invention is to provide an electro-optical device effective in solving the above problem. An advantage of another aspect of the invention is to provide a method of manufacturing the electro-optical device.

A first aspect of the present invention provides an electro-optical device including a substrate, a first light-shielding layer which overlies the substrate and which has a predetermined width, a first interlayer insulating layer overlying the first light-shielding layer, a transistor disposed on the first interlayer insulating layer, a second interlayer insulating layer overlying the transistor, and a second light-shielding layer overlying the second interlayer insulating layer. The transistor includes a semiconductor layer that has a surface which faces the substrate and which is covered with the first light-shielding layer and that also has a surface which faces a direction opposite to the substrate and which is covered with the second light-shielding layer. The second light-shielding layer has a width greater than that of the first light-shielding layer. The first interlayer insulating layer has a thinnest portion that is located between an end portion of the first light-shielding layer and an end portion of the second light-shielding layer in plan view.

According to this configuration, the second interlayer insulating layer, which overlies the first interlayer insulating layer, can cover side surfaces of the transistor. The second light-shielding layer, which overlies the second interlayer insulating layer, covers side surfaces of the transistor. Therefore, the influence of light transversely or obliquely incident on the transistor can be reduced.

A second aspect of the present invention provides an electro-optical device including a substrate, a first light-shielding layer which overlies the substrate and which has a predetermined width, a first interlayer insulating layer overlying the first light-shielding layer, a transistor disposed on the first interlayer insulating layer, a second interlayer insulating layer overlying the transistor, and a second light-shielding layer overlying the second interlayer insulating layer. The transistor includes a semiconductor layer that has a surface which faces the substrate and which is covered with the first light-shielding layer and that also has a surface which faces a direction opposite to the substrate and which is covered with the second light-shielding layer. The second light-shielding layer has a width greater than that of the first light-shielding layer. A zone where the distance between the first light-shielding layer and the first interlayer insulating layer is shortest is present between an end portion of the first light-shielding layer and an end portion of the second light-shielding layer in plan view.

According to this configuration, the second interlayer insulating layer, which overlies the first interlayer insulating layer, can cover side surfaces of the transistor. The second light-shielding layer covers side surfaces of the transistor. Therefore, light can be prevented from being transversely or obliquely incident on the transistor, whereby the electro-optical device can be prevented from being reduced in display quality due to leakage currents.

A third aspect of the present invention provides an electro-optical device including a substrate, a first light-shielding layer which overlies the substrate and which has a predetermined widths a first interlayer insulating layer overlying the first light-shielding layer, a transistor disposed on the first interlayer insulating layer, a second interlayer insulating layer overlying the transistor, and a second light-shielding layer overlying the second interlayer insulating layer. The transistor includes a semiconductor layer that has a surface which faces the substrate and which is covered with the first light-shielding layer and that also has a surface which faces a direction opposite to the substrate and which is covered with the second light-shielding layer. The second light-shielding layer has a width greater than that of the first light-shielding layer. A zone where the distance between the second interlayer insulating layer and the substrate is shortest is present between an end portion of the first light-shielding layer and an end portion of the second light-shielding layer in plan view.

According to this configuration, the second light-shielding layer can cover not only the upper surface of the transistor but also side surfaces thereof. Therefore, light can be prevented from being transversely or obliquely incident on the transistor, whereby the electro-optical device can be prevented from being reduced in display quality due to leakage currents.

A fourth aspect of the present invention provides an electro-optical device including a substrates a first light-shielding layer which overlies the substrate and which has a predetermined width, a first interlayer insulating layer overlying the first light-shielding layer, a transistor disposed on the first interlayer insulating layer, a second interlayer insulating layer overlying the transistor, and a second light-shielding layer overlying the second interlayer insulating layer. The transistor includes a semiconductor layer that has a surface which faces the substrate and which is covered with the first light-shielding layer and that also has a surface which faces a direction opposite to the substrate and which is covered with the second light-shielding layer. The second light-shielding layer has a width greater than that of the first light-shielding layer. A zone where the distance between the first light-shielding layer and the second interlayer insulating layer is shortest is present between an end portion of the first light-shielding layer and an end portion of the second light-shielding layer in plan view.

According to this configuration, the second interlayer insulating layer, which overlies the first interlayer insulating layer, can cover side surfaces of the transistor. The second light-shielding layer, which overlies the second interlayer insulating layer, covers side surfaces of the transistor. Therefore, the influence of light transversely or obliquely incident on the transistor can be reduced, whereby the electro-optical device can be prevented from being reduced in display quality due to leakage currents.

In the electro-optical device according to any one of the first to fourth aspects, at least one of the first and second interlayer insulating layers is formed by an HDP-CVD process.

According to the HDP-CVD process, an interlayer insulating layer can be prevented from being grown (deposited) on a sidewall portion of a base pattern. Therefore, the second light-shielding layer can cover side surfaces of the transistor, whereby the electro-optical device can be prevented from being reduced in display quality due to leakage currents.

A fifth aspect of the present invention provides a method of manufacturing an electro-optical device. The method includes a first step of forming a first light-shielding layer having a predetermined width on a substrate, a second step of forming a first interlayer insulating layer over the substrate, a third step of forming a transistor on the first interlayer insulating layer, a fourth step of forming a second interlayer insulating layer over the transistor, and a fifth step of forming a second light-shielding layer over the second interlayer insulating layer to cover the transistor. At least one of the first and second interlayer insulating layers is formed by an HDP-CVD process in the first or second step.

According to the method, the first or second interlayer insulating layer can be prevented from being grown (deposited) on a sidewall portion of a base pattern. Therefore, the second light-shielding layer can be formed so as to cover side surfaces of the transistor, whereby the electro-optical device can be prevented from being reduced in display quality due to leakage currents.

### BRIEF DESCRIPTION OF THE DRAWINGS

The invention will be described with reference to the accompanying drawings, wherein like numbers reference like elements.

FIG. 1 is a schematic plan view of a liquid crystal device according to an embodiment of the present invention.

FIG. 2 is a schematic sectional view of the liquid crystal device taken along the line II-II of FIG. 1.

FIG. 3 is a circuit diagram of the liquid crystal device shown in FIG. 1.

FIG. 4 is a plan view of pixel sections disposed in the liquid crystal device shown in FIG. 1.

FIG. 5 is a schematic sectional view of a TFT taken along the line V-V of FIG. 4.

FIG. 6 is a schematic sectional view of a conventional TFT.

FIG. 7 is a perspective view of a projector which is an electronic apparatus.

### DESCRIPTION OF EXEMPLARY EMBODIMENTS

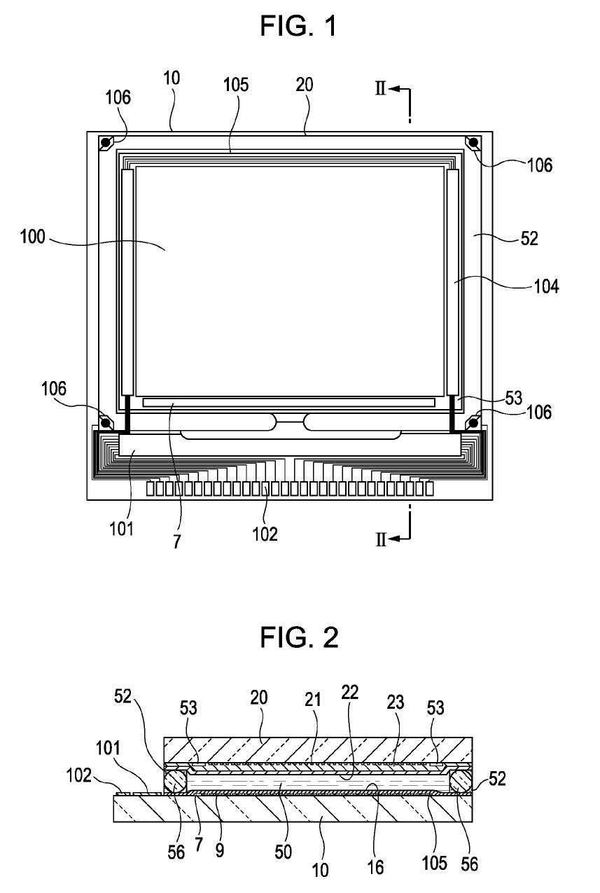

Embodiments of the present invention will now be described with reference to FIGS. 1 to 6 using an active matrix addressing-type transmissive liquid crystal device that is an example of an electro-optical device according to the present invention. In the drawings, in order to show members on a recognizable scale, different scales are used depending on the size of the members.

The liquid crystal display will now be described with reference to FIGS. 1 and 2. FIG. 1 is a schematic plan view of the liquid crystal device, which is viewed from a counter substrate 20 facing an element substrate 10 carrying various members. FIG. 2 is a schematic sectional view of the liquid crystal device taken along the line II-II of FIG. 1.

With reference to FIGS. 1 and 2, the liquid crystal device includes the element substrate 10 and the counter substrate 20, which faces the element substrate 10. The element substrate 10 is made of quartz, glass, or silicon and is transparent. The counter substrate 20 is also made of such a material and is transparent. A liquid crystal layer 50 is sealed between the element substrate 10 and the counter substrate 20. The element substrate 10 and the counter substrate 20 are attached to each other with a sealing member 52 made of an ultraviolet-curable resin, a heat-curable resin, or a similar resin. The sealing member 52 extends around a display region 100 and contains gap spacers 56, such as glass fibers or glass beads, for maintaining the gap (inter-substrate gap) between the element substrate 10 and the counter substrate 20 at a predetermined value.

The counter substrate 20 is overlaid with a frame light-shielding layer 53 for defining a frame sub-region of the display region 100. The frame light-shielding layer 53 extends in parallel to an inner portion of a sealing region surrounded by the sealing member 52. A surrounding region extending around the display region 100 is disposed on the element substrate 10 and includes a data line-driving circuit 101, a sampling circuit 7, scanning line-driving circuits 104, and external-circuit connection terminals 102. The data line-driving circuit 101 and the external-circuit connection terminals 102 are located outside the sealing region and are arranged along a side of the element substrate 10.

The scanning line-driving circuits 104 each extend along a corresponding one of two sides of the element substrate 10 and are covered with the frame light-shielding layer 53. A plurality of wiring lines 105 for electrically connecting the scanning line-driving circuits 104, which extend along both sides of the display region 100, to each other extend along the other one side of the element substrate 10 and are covered with the frame light-shielding layer 53. The surrounding region, which is disposed on the element substrate 10, includes vertical conduction terminals 106 located at positions corresponding to four corners of the counter substrate 20. The element substrate 10 and the counter substrate 20 sandwich vertical conductors electrically connected to the vertical conduction terminals 106.

With reference to FIG. 2, the element substrate 10 carries a multilayer structure containing TFTs 30 for switching, scanning lines 11, data lines 6, and other lines. The display region 100 includes pixel electrodes 9 arranged above the TFTs 30, the scanning lines 11, and the data lines 6 in a matrix pattern. The pixel electrodes 9 are overlaid with a first alignment layer 16.

A surface of the counter substrate 20 that faces the element substrate 10 is overlaid with a light-shielding layer 23. The light-shielding layer 23 is made of, for example, a light-shielding metal or the like and has, for example, a grid pattern disposed in the display region 100, which is disposed on the counter substrate 20. A counter electrode 21 made of a transparent material such as indium tin oxide (ITO) extends over the light-shielding layer 23 so as to face the pixel electrodes 9. With reference to FIG. 2, the counter electrode 21 underlies the light-shielding layer 23. The counter electrode 21 is overlaid with a second alignment layer 22.

The liquid crystal layer 50 contains, for example, a nematic liquid crystal or a mixture of several types of nematic liquid crystals and is maintained in a predetermined oriented state because the liquid crystal layer 50 is disposed between the first and second alignment layers 16 and 22. When the liquid crystal device is operated, voltages are applied between the counter electrode 21 and the pixel electrodes 9, whereby liquid-crystal storage capacitors are formed between the counter electrode 21 and the pixel electrodes 9.

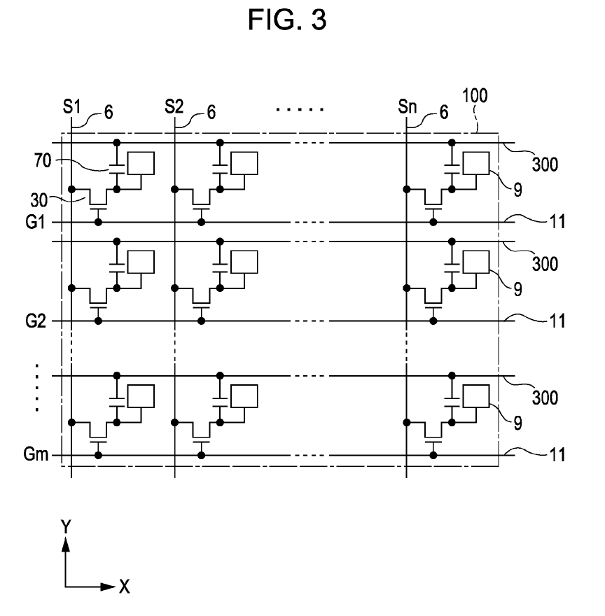

The configuration of pixel sections of the liquid crystal device will now be described with reference to FIG. 3. FIG. 3 is a circuit diagram of the liquid crystal device. With reference to FIG. 3, in the display region 100, the scanning lines 11 and capacitor lines 300 extend in an X-direction and the data lines 6 extend in a Y-direction. Each of a plurality of pixels defined by these lines includes a corresponding one of the pixel electrodes 9 and a corresponding one of the TFTs 30. The TFTs 30 are electrically connected to the pixel electrodes 9 to control the switching of the pixel electrodes 9 upon the operation of the liquid crystal device. The data lines 6 are supplied with image signals S1, S2, . . . , and Sn and electrically connected to the sources of the TFTs 30. The image signals S1, S2, . . . , and Sn are sequentially supplied to the data lines 6 in that order.

The scanning lines 11 are electrically connected to the gates of the TFTs 30. The liquid crystal device is configured such that scanning signals G1, G2, . . . , and Gn are sequentially applied to the scanning lines 11 at predetermined timing in a pulsed mode in that order. The pixel electrodes 9 are electrically connected to the drains of the TFTs 30. The image signals S1, S2, . . . , and Sn are supplied from the data lines 6 to the pixel electrodes 9 and then written in the pixel electrodes 9 in such a manner that the TFTs 30, which are switching elements, are switched on for a predetermined time. The image signals S1, S2, . . . , and Sn are further written in the liquid crystal layer 50 through the pixel electrodes 9 and then maintained between the liquid crystal layer 50 and the counter electrode 21, which underlies the counter substrate 20, for a predetermined period at a predetermined level. The liquid crystal or liquid crystals contained in the liquid crystal layer 50 (see FIG. 2) can be used to display a halftone image in such a manner that the orientation or order of molecules thereof is varied depending on the level of voltages applied to the molecules such that light is modulated.

In order to prevent retained image signals from leaking, storage capacitors 70 are arranged in electrical parallel to the liquid-crystal storage capacitors, which are arranged between the counter electrode 21 (see FIG. 2) and the pixel electrodes 9. The storage capacitors 70 temporally hold the potentials of the pixel electrodes 9 in response to the supply of image signals. One electrode of each of the storage capacitors 70 is electrically connected to the drain of a corresponding one of the TFTs 30 in electrical parallel to a corresponding one of the pixel electrodes 9 and the other electrode is electrically connected to a corresponding one of the capacitor lines 300, which are equipotential, so as to be equipotential. The storage capacitors 70 function as light-shielding layers for shielding the TFTs 30 from light as described below.

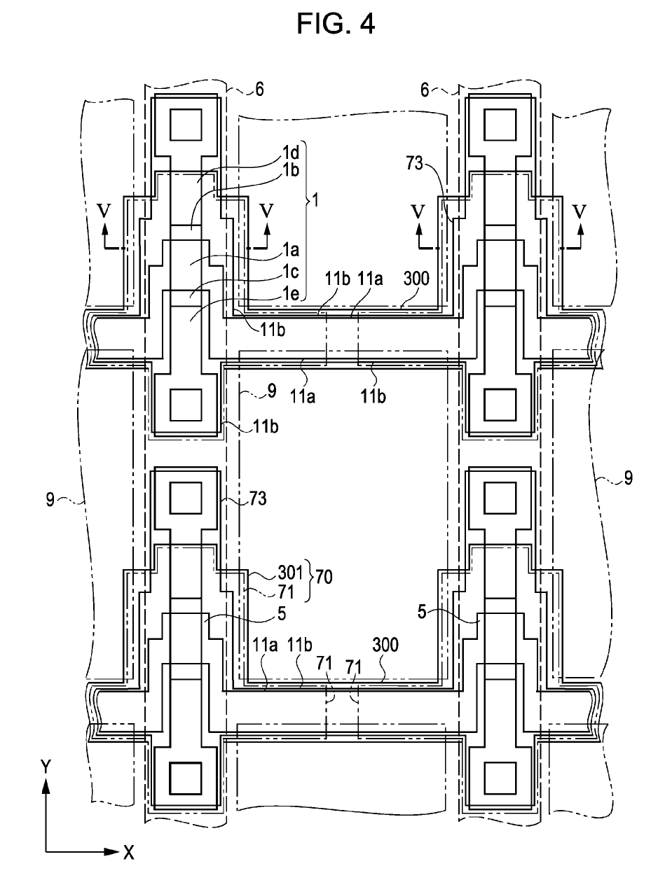

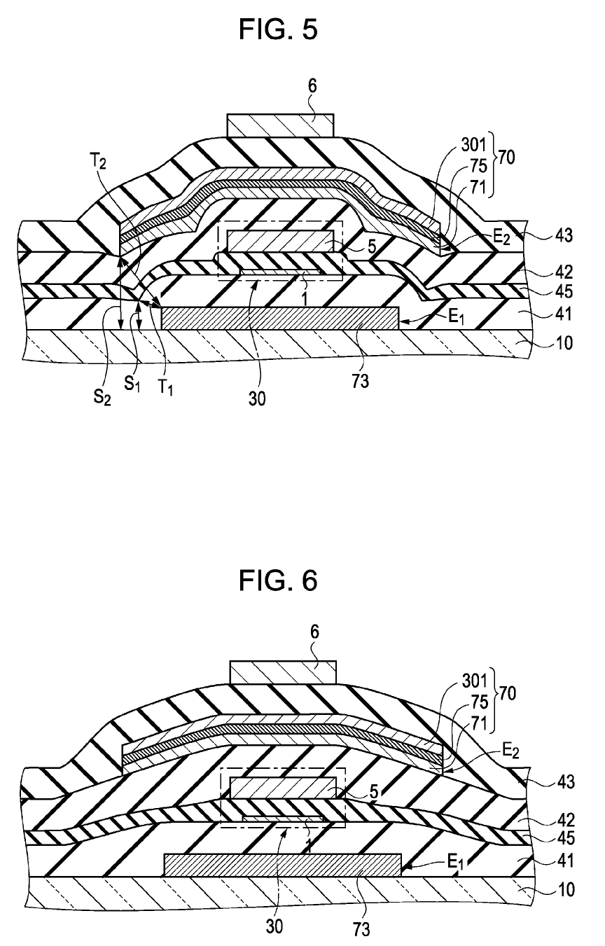

The configuration of the pixel sections, particularly the configuration of the TFTs 30, will now be described with reference to FIGS. 4 and 5. FIG. 4 is a plan view of the pixel sections, which are regularly arranged in the display region 100 of the liquid crystal device. FIG. 5 is a schematic sectional view of one of the TFTs 30 taken along the line V-V of FIG. 4. In FIGS. 4 and 5, in order to show members on a recognizable scale, different scales are used depending on the size of the members. Only components located on the element substrate 10 side are described below with reference to FIGS. 4 and 5; however, some of components described above with reference to FIG. 1 or 2 are not shown in FIG. 4 or 5.

With reference to FIG. 4, wiring lines extend in the display region 100 (see FIG. 3) to form a grid pattern. Each of the pixel electrodes 9 is disposed in a corresponding one of substantially rectangular regions defined by the wiring lines. The scanning lines 11 (upper scanning sub-lines 11a and lower scanning sub-lines 11b) and the capacitor lines 300 extend in an X-direction. The data lines 6 extend in a Y-direction. In order to achieve an increased aperture ratio, the TFTs 30 and the storage capacitors 70 are arranged to overlap with the above wiring lines in plan view.

A lower light-shielding layer (first light-shielding layer) and upper light-shielding layer (second light-shielding layer) for shielding the TFTs 30 from light are arranged to overlap with the above wiring lines in plan view. The lower light-shielding layer is located on the element substrate 10 side of the TFTs 30 and the upper light-shielding layer is located on the counter substrate 20 side of the TFTs 30. The wiring lines function as light-shielding layers.

With reference to FIG. 5, each TFT 30 includes a semiconductor layer 1 made of polycrystalline silicon, a gate electrode 5, and a gate insulating layer 45. The TFT 30 has an LDD structure. The semiconductor layer 1 includes a channel region 1a having a channel extending in the Y-direction, a data line-side LDD region 1b, a pixel electrode-side LDD region 1c, a data line-side source-drain region 1d, and a pixel electrode-side source-drain region 1e. The gate length and channel length of the TFT 30 are substantially equal to each other. A direction perpendicular to the length direction of the gate of the TFT 30 is the width direction of the gate thereof.

The data line-side LDD region 1b, pixel electrode-side LDD region 1c, data line-side source-drain region 1d, and pixel electrode-side source-drain region 1e other than the channel region 1a are regions doped with an impurity such as phosphorus (P) by an ion implantation process. The data line-side LDD region 1b and the pixel electrode-side LDD region 1c have an impurity content less than that of the data line-side source-drain region 1d and that of pixel electrode-side source-drain region 1e. This configuration reduces off-currents flowing through the data line-side source-drain region 1d and the pixel electrode-side source-drain region 1e during the non-operation of the TFTs 30 and prevents the reduction of on-currents flowing therethrough during the operation of the TFTs 30.

The scanning lines 11 each have a two-component structure which is disposed in the display region 100 and which includes a upper scanning sub-line 11a and a lower scanning sub-line 11b. With reference to FIGS. 4 and 5, the gate electrode 5 is a portion of the upper scanning sub-line 11a. The upper scanning sub-line 11a is made of, for example, polycrystalline silicon or the like and has a first portion extending in the X-direction and a second portion that extends in the Y-direction so as to partly overlap with the semiconductor layer 1 of the TFT 30. A portion of the upper scanning sub-line 11a that overlaps with the channel region 1a functions as the gate electrode 5. The gate electrode 5 is insulated from the semiconductor layer 1 with the gate insulating layer 45.

The lower scanning sub-line 11b extends below the semiconductor layer 1 with a first interlayer insulating layer 41 extending therebetween and is located on the element substrate 10 side. The lower scanning sub-line 11b is made of, for example, a light-shielding conductive material such as a refractory metal material including tungsten (W), titanium (Ti), and titanium nitride (TiN). The lower scanning sub-line 11b has a principal portion extending in the X-direction and an extending portion extending from the principal portion in the Y-direction. The extending portion overlap with the semiconductor layer 1 of the TFT 30 in plan view and functions as a first light-shielding layer 73 for shielding the TFT 30 from returning light reflected by the rear surface of the element substrate 10. The lower scanning sub-line 11b is insulated from the semiconductor layer 1 with the first interlayer insulating layer 41.

The storage capacitors 70 are disposed above the TFTs 30, which are disposed above the element substrate 10, with a second interlayer insulating layer 42 extending therebetween, that is, the storage capacitors 70 are located on the counter substrate 20 side. With reference to FIG. 5, each storage capacitor 70 includes a dielectric layer 75, a lower capacitor electrode 71, and an upper capacitor electrode 301 spaced from the lower capacitor electrode 71 with the dielectric layer 75 disposed therebetween. The upper capacitor electrode 301 is a portion of a corresponding one of the capacitor lines 300, the portion thereof extending in the Y-direction. The capacitor lines 300 are made of made of a metal such as aluminum (Al) or silver (Ag) or an alloy containing Al or Ag and can block light traveling from the counter substrate 20. The lower capacitor electrode 71 is an independent conductive layer made of polycrystalline silicon or the like and is electrically connected to the pixel electrode-side source-drain region 1e of a corresponding one of the TFTs 30 and a corresponding one of the pixel electrodes 9 through a contact hole, which is not shown. The lower capacitor electrodes 71 and the upper capacitor electrodes 301, particularly the upper capacitor electrode 301, function as light-shielding layers for shielding the TFTs 30 from light; hence, the storage capacitors 70 are hereinafter referred to as second light-shielding layers (storage capacitors) 70. The pixel electrodes 9 are electrically connected to the lower capacitor electrode 71 through relay electrodes and contact holes, which are not shown.

The data lines 6 extend above the second light-shielding layers (storage capacitors) 70 with a third interlayer insulating layer 43 lying therebetween, that is, the data lines 6 are located on the counter substrate 20 side. The data lines 6 are electrically connected to the data line-side source-drain regions 1d of the semiconductor layers 1 through a contact hole, which is not shown. The data lines 6 have a function of shielding the TFTs 30 from light.

The pixel electrodes 9 are disposed above the data lines 6 with a fourth interlayer insulating layer (not shown) extending therebetween, that is, the pixel electrodes 9 are located on the counter substrate 20 side. The pixel electrodes 9 are electrically connected to the lower capacitor electrodes 71 and also electrically connected to the pixel electrode-side source-drain regions 1e of the semiconductor layers 1 through contact holes and relay electrodes, which are not shown.

As described above, in the liquid crystal device, the TFTs 30 are shielded from light in such a manner that the TFTs 30 are arranged between the light-shielding layers. The light-shielding layers are enhanced in light-shielding ability (light-shielding function) in such a manner that the interlayer insulating layers are improved in shape or formed by an improved process; hence, light can be prevented from being transversely or obliquely incident on the TFTs 30. The shape and the like of the interlayer insulating layers are described below with reference to FIG. 5.

FIG. 5 is a schematic sectional view of one of the TFTs 30 taken along the line V-V of FIG. 4 and illustrates the cross-sectional shape of one of the second light-shielding layers (storage capacitors) 70. In FIG. 6, the element substrate 10, one of the TFTs 30, and components disposed therebetween are shown and the pixel electrodes 9 are not shown. The Y-direction is perpendicular to the element substrate 10 and the X-direction Is parallel to the gate width direction. The size of each second light-shielding layer (storage capacitor) 70 in the gate width direction is greater than that of the first light-shielding layer 73. Therefore, a first end portion E₁ of the first light-shielding layer 73 is located inside a second end portion E₂ of the second light-shielding layer (storage capacitor) 70, that is, the first end portion E₁ is closer to a corresponding one of the TFTs 30 than the second end portion E₂. The first interlayer insulating layer 41 has stepped portions due to the first light-shielding layer 73. The stepped portions are not so thick and extend sharply downward to the element substrate 10. Therefore, at least one of the following portions is located in a region sandwiched between the first and second end portions E₁ and E₂: a first thinnest portion S₁ of the first interlayer insulating layer 41 and a first shortest zone T₁ where the distance between the first light-shielding layer 73 and the first interlayer insulating layer 41 is shortest.

The second interlayer insulating layer 42, as well as the first interlayer insulating layer 41, has stepped portions due to the first light-shielding layer 73. The stepped portions of the second interlayer insulating layer 42 are not so thick and extend sharply downward to the element substrate 10. Therefore, at least one of the following portions is located in the region sandwiched between the first and second end portions E₁ and E₂: a second thinnest portion S₂ where the distance between the second interlayer insulating layer 42 and the element substrate 10 is shortest and a second shortest zone T₂ where the distance between the first light-shielding layer 73 and the second interlayer insulating layer 42 is shortest.

Since the first and second interlayer insulating layers 41 and 42 both have the stepped portions, which extend sharply downward to the element substrate 10, and the stepped portions are located in the region sandwiched between the first and second end portions E₁ and E₂, the distance between the second interlayer insulating layer 42 and the element substrate 10 is extremely short in the region. Therefore, the second light-shielding layers (storage capacitors) 70, which are disposed on the second interlayer insulating layer 42, cover not only the upper surfaces of the TFTs 30 but also side surfaces thereof. Light is securely prevented from being transversely (horizontally) or obliquely incident on the TFTs 30.

The above-mentioned shape of the first and second interlayer insulating layers 41 and 42 can be achieved in such a manner that the first and second interlayer insulating layers 41 and 42 are formed by a high-density plasma chemical vapor deposition (HDP-CVD) process. The HDP-CVD process allows deposition and sputtering (etching by sputtering) to be simultaneously performed. The ratio of the deposition rate of the first or second interlayer insulating layer 41 or 42 to the etching rate thereof can be controlled within a predetermined range depending on preset conditions. The etching rate is maximized when the angle of sputtering ions incident on the element substrate 10 is about 50 degrees. The deposition of the first or second interlayer insulating layer 41 or 42 together with the sputtering of the first or second interlayer insulating layer 41 or 42, respectively, at this angle allows the deposition rate of a portion of the first or second interlayer insulating layer 41 or 42 that is located near the first end portion E₁ to be greater than the etching rate thereof; hence, the first and second interlayer insulating layers 41 and 42 have a sharply stepped shape as shown in FIG. 5.

FIG. 6 is a schematic sectional view of a conventional TFT 30, located at a position similar to a position where the TFT 30 shown in FIG. 5 is located, for comparison. Components, shown in FIG. 6, common to those of the liquid crystal device shown in FIG. 5 have the same reference numerals as those shown in FIG. 5 and will not be described in detail. A first interlayer insulating layer 41 and second interlayer insulating layer 42 shown in FIG. 6 are formed by a known CVD process. Therefore, these first and second interlayer insulating layers 41 and 42 have thick portions located near a first end portion E₁. A second light-shielding layer (storage capacitor) 70 formed on or above these first and second interlayer insulating layers 41 and 42 covers only the upper surface of this TFT 30.

In the liquid crystal device, the first and second interlayer insulating layers 41 and 42 are formed by the HDP-CVD process so as to have the stepped portions, which are located near the first end portion E₁, and therefore have an enhanced ability to shield the TFTs 30 from light although an increased number of forming steps are not used. This allows the liquid crystal device to be prevented from being reduced in display quality due to leakage currents.

In this embodiment, the first and second interlayer insulating layers 41 and 42 are both formed by the HDP-CVD process. However, even if one of the first and second interlayer insulating layers 41 and 42 is formed by the HDP-CVD process, the above advantage can be achieved.

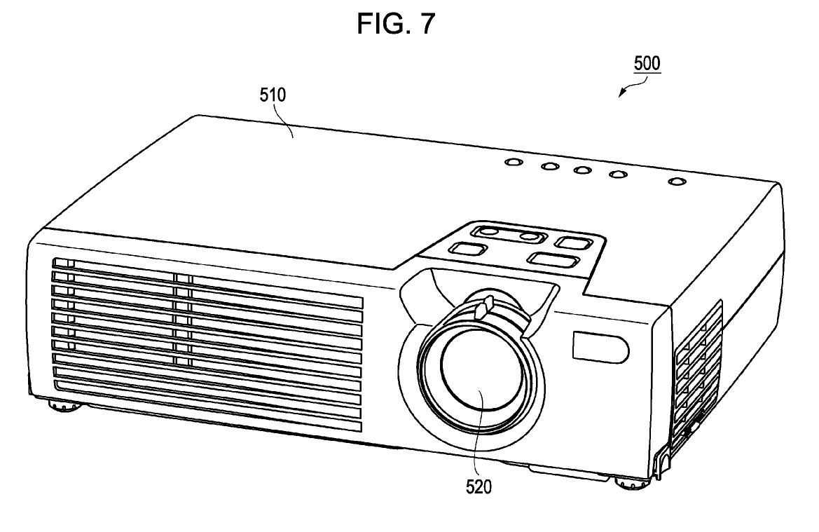

The liquid crystal device can be mount in a projector 500 shown in FIG. 7. The projector 500 is an electronic apparatus. The projector 500 includes a body 510 and a lens 520. In the projector 500, light is emitted from a light source (not shown) disposed in the projector 500, modulated with the liquid crystal device which is placed in the projector 500 so as to serve as a display section or a light valve, and then projected through the lens 520. The projector 500 includes the TFTs 30, which are shielded from light, and therefore can display a high-quality image without being affected by photo-leakage currents or the like.

The liquid crystal device described in the above embodiment is of a transmissive type. The present invention is applicable to a reflective liquid crystal device. The reflective liquid crystal device, as well as a transmissive liquid crystal device, can be prevented from being reduced in display quality by leakage currents because TFTs contained in the reflective liquid crystal device can be shielded from external light useless for displaying an image.

What is claimed is:

1. An electro-optical device comprising:
a substrate;
a first light-shielding layer over the substrate;
a first interlayer insulating layer over the first light-shielding layer;
a transistor over the first interlayer insulating layer, the transistor having a semiconductor layer, the semiconductor layer covering with the first light-shielding layer;
a second interlayer insulating layer over the transistor; and
a second light-shielding layer over the second interlayer insulating layer, the second light-shielding layer overlapping with the semiconductor layer and having a width greater than that of the first light-shielding layer,
wherein the first interlayer insulating layer has a thinnest portion that is located between an end portion of the first light-shielding layer and an end portion of the second light-shielding layer in plan view.

2. The electro-optical device according to claim 1, a zone where the distance between the first light-shielding layer and the first interlayer insulating layer is shortest is present between an end portion of the first light-shielding layer and an end portion of the second light-shielding layer in plan view.

3. The electro-optical device according to claim 1, a zone where the distance between the second interlayer insulating layer and the substrate is shortest is present between an end portion of the first light-shielding layer and an end portion of the second light-shielding layer in plan view.

4. The electro-optical device according to claim 1, a zone where the distance between the first light-shielding layer and the second interlayer insulating layer is shortest is present between an end portion of the first light-shielding layer and an end portion of the second light-shielding layer in plan view.

5. The electro-optical device according to claim 1, wherein at least one of the first and second interlayer insulating layers is formed by an HDP-CVD process.
